(19) United States
(12) Patent Application Publication
(10) Pub. No.: US 2005/0246863 A1
(43) Pub. Date: Nov. 10, 2005

(54) Hinge with damper control

(76) Inventors: Graham M. Chesworth, Beckenham (GB); Raymond D. Hackney, Cuffley (GB)

Correspondence Address: Clifford W. Browning;Suite 3700, 111 Monument Circle, Indianapolis, IN, 46204-5137, US

(21) Appl. No.: 11/103,868

(22) Filed: Apr. 12, 2005

(30) Foreign Application Priority Data
Sep. 10, 2003 (GB) GB0323706.2

(51) Int. Cl. E05D 1/00

(52) U.S. Cl. 16/221

(57) ABSTRACT

A hinge (10) that is arranged to be self-closing by the provision of two inter-engaged parts that are pivotable relative to one another, by each part including a respective barrel portion (30, 50), the two barrel portions (30, 50) being coaxially and end-to-end. Juxtaposed ends of the barrel portions (30, 50) each have a respective cam insert (35) therein. The cam inserts (35) are arranged such that an axial compressive force acting through the axis of the hinge (10) causes the hinge (10) to close. One of the barrel portions (50) is extended and has a damper (72) positioned therein. The damper (72) dampens relative axial movement of the two parts of the hinge (10). Thus, a door mounted on the hinge (10) in a door frame has its movement damped and tends not to slam closed.

This invention relates to hinges. In particular, but not exclusively, it relates to hinges that are of the type that are self-closing. This invention also relates to doors to which such hinges are fitted.

Some doors are provided with self-closing hinges. These hinges usually have a cam arrangement such that opening the hinge causes axial separation of one mounting bracket of the hinge from the other mounting bracket, with respect to the pivot axis of the hinge. When such a hinge is used to support a door in a frame with one bracket attached to the door and the other to the frame, opening the door causes the hinge to open and therefore brings about the aforementioned axial separation. The hinge is arranged such that this axial separation causes the door to be lifted up a little with respect to the door frame. The weight of the door tends to resist this lifting up and therefore to resist its opening such that the door has a tendency to close when open. Thus, the door and the hinge may be considered self-closing.

A disadvantage of such self-closing hinges is that doors to which they are fitted have a tendency to slam shut with considerable speed and noise. This is unsettling to persons nearby and may result in damage to the door or to nearby structure.

An object of this invention is to address this problem.

According to one aspect of this invention there is provided a hinge having one part pivotable relative to another part about an axis, each part also being axially moveable relative to the other, wherein the hinge includes damping means arranged to dampen at least some axial movement of the one part relative to the other.

Damping axial movement of one part of the hinge relative to the other is advantageous in, for example, slowing the closing of a door to which the hinge is fitted and which descends on its hinges as it closes. Thus, slamming of the door may be avoided.

The damping means may be arranged such that it dampens axial coming together of the two parts of the hinge. The damping means may be arranged such that it dampens axial separation of the two parts of the hinge.

Preferably, the damping means has a first part and another part, one part of the damping means being arranged to be acted upon by one part of the hinge and the other part of the damping means being arranged to be acted upon by the other part of the hinge, the damping means being arranged such that at least some movement of the one part of the damping means relative to the other part of the damping means is damped. Preferably the hinge is arranged such that the damping means is acted upon in a substantially axial direction by the two parts of the hinge. That direction need not be co-axial with the direction of the hinge, but may, for example, be parallel to the axis of the hinge.

The first part of the damping means may include a plunger and the other part of the damping means may include a housing, the plunger being mounted for damped movement in the housing. Preferably the hinge is arranged such that the plunger is moveable in a substantially axial direction. The damper may be mounted to the hinge such that the plunger is coaxial with the pivot axis. The damper may also be arranged such that the plunger is resiliently mounted in the housing to end to return to a position at which it is partially withdrawn from the housing.

The hinge may be a self-closing hinge. The hinge may be a self-opening hinge. The hinge may be arranged such that an axial compressive or tensile force acting on the two parts of the hinge causes the one part of the hinge to pivot relative to the other part of the hinge. This force may cause the hinge to pivot open or to pivot closed. The hinge may include a cam arrangement that gives this result.

Each part of the hinge may include a respective mounting portion and a respective pivot portion, each mounting portion being for mounting, for example, a door, a door frame or the floor, and each pivot portion being for pivotally engaging the respective other pivot portion such that the one part of the hinge can pivot relative to the other part. One or both mounting portions may be a mounting bracket and may be for fitting to a surface that extends in an axial direction and/or to a surface that extends in a radial direction. This may be achieved by one or both mounting brackets extending in an axial or a radial direction. Each pivot portion may include a respective barrel portion for receiving a pin that is also received in the respective other barrel portion. At least one of the pivot portions may house the damping means. The damping means may be operable to act on the pin and also on one pivot portion, the other pivot portion being arranged such that it is acted on by the pin. The pin may be fixed to the other pivot portion.

According to another aspect of this invention there is provided a door that includes the hinge

The door may include a cut-out, such as a channel, in which at least part of the hinge is located. The housing of the damper may be located in the cut out.

Specific embodiments of this invention are now described by way of example only and with reference to the accompanying drawings, in which:

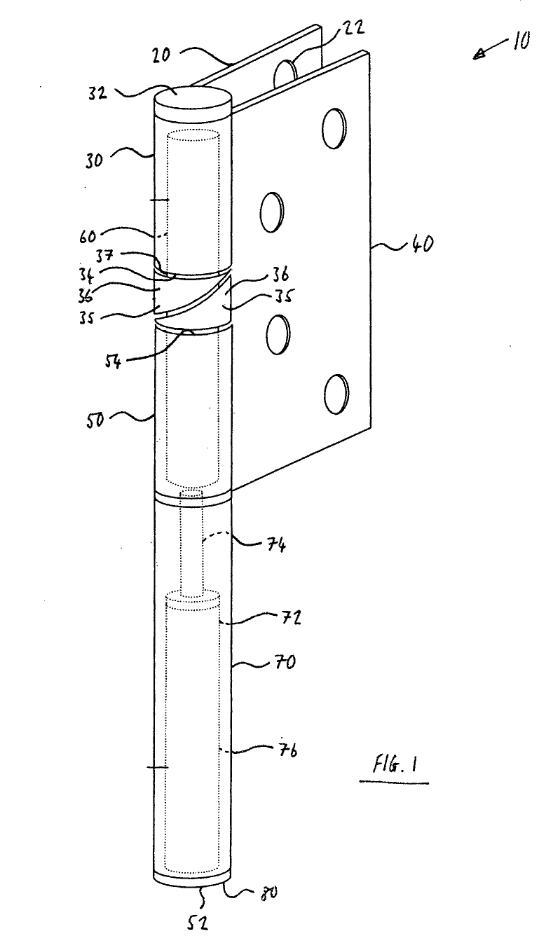

FIG. 1 is a perspective view of a first hinge that includes a cam so as to be self-closing;

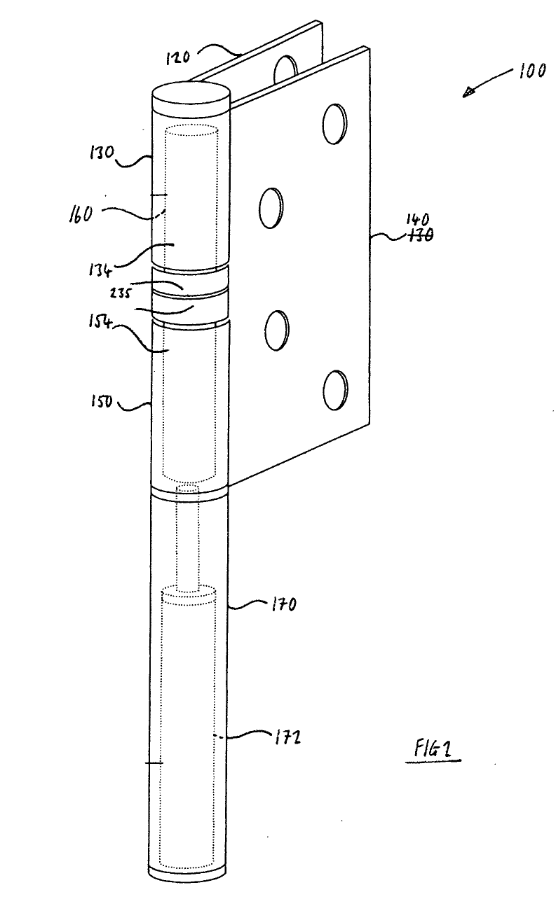

FIG. 2 is a perspective view of an alternative hinge that is not self-closing;

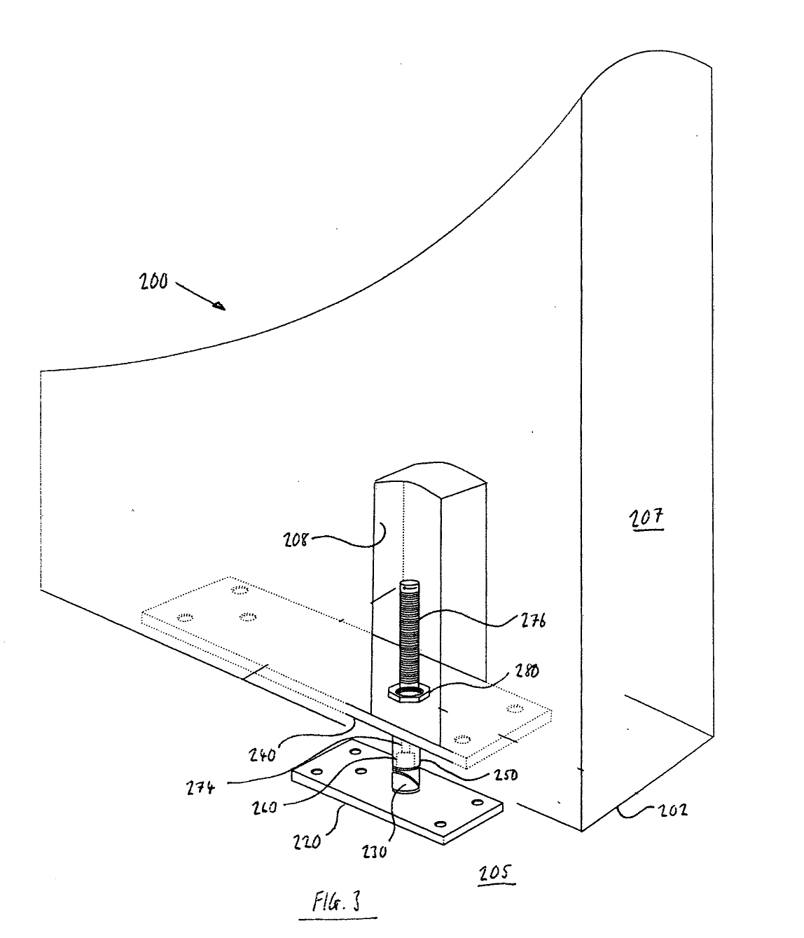

FIG. 3 is a perspective view of part of a door and of a floor-mounted hinge fitted thereto in a channel in a face of the door;

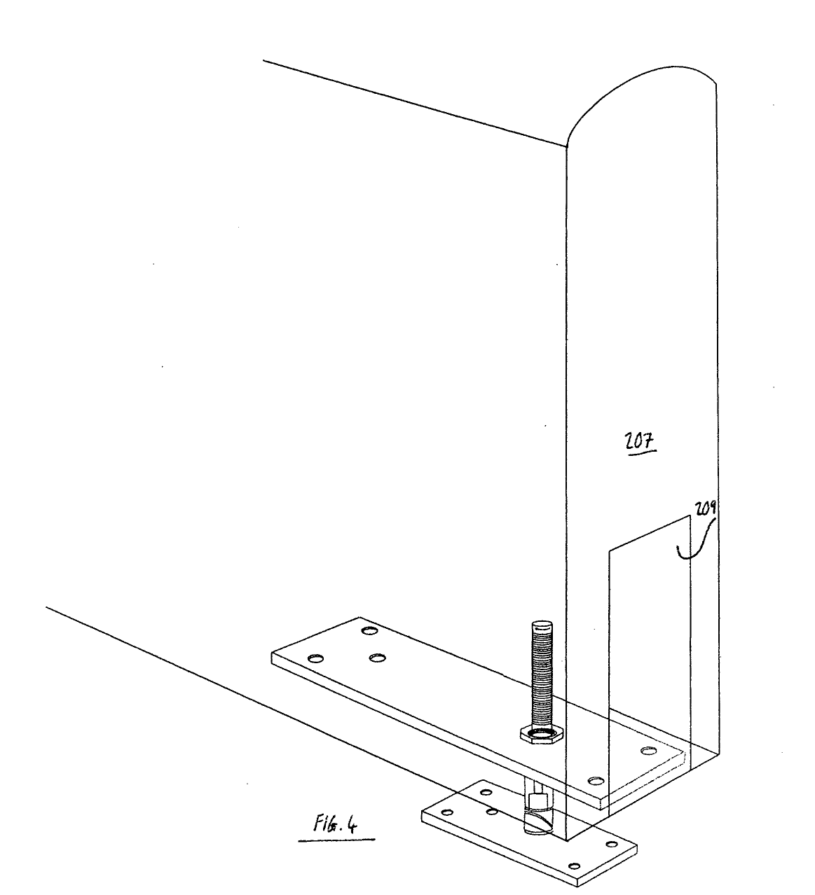

FIG. 4 is a perspective view of part of another door with the floor-mounted hinge fitted thereto in a channel in an edge of the door; and

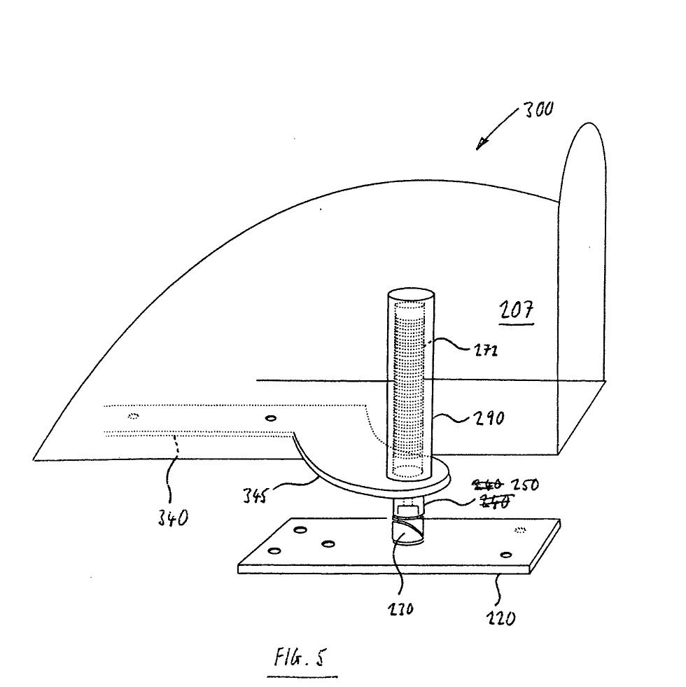

FIG. 5 is a perspective view of part of a further door and of an offset floor-mounted hinge fitted thereto by way of a projecting arm fitted to a lower edge of the door.

FIG. 1 shows a hinge 10, which, in common with known hinges, is comprised principally of two inter-engaged parts that are pivotable relative to one another. A first one of the parts includes a first mounting bracket 20 with a first barrel portion 30 formed thereon. The mounting bracket 20 is a generally rectangular, flat, web with four screw-receiving holes 22 formed therethrough. The first barrel portion 30 is formed along a long edge of the mounting bracket 20 so as to run from an end of that edge to a position short of half way along its length. The barrel portion 30 is formed from material that is integral with the bracket 20 and that has been rolled back on itself to substantially form a cylinder. The end 32 of the first barrel portion 30 that is adjacent the end of the bracket edge is closed, but the other end 34 of the first barrel portion 30 that is adjacent the middle of the edge is open.

A cam insert 35 is positioned in this open end 34. The cam insert 35 has a body portion 36 with a curved outer surface of substantially the same radius as that of the outside of the barrel 30. The cam insert 35 also includes a spigot portion 37 of lesser diameter for spigotting inside the barrel 30 such that the body portion 36 of the cam insert 35 abuts the open end 34 of the barrel portion 30. A distal end of the body portion 36 of the cam insert 35 is shaped to have a helical profile that is co-axial: with the pivot axis.

To locate the cam insert 35 in the first barrel portion 30, a locating pin 38 is positioned in a cooperating hole in each of the first barrel portion 30 and the spigot portion 36.

The second one of the parts is, in many aspects, the same as the first one and includes a second mounting bracket 40, with a second integral barrel portion 50 formed thereon. The second mounting bracket 40 is substantially the same as the first mounting bracket 20, and the second barrel portion 50 is substantially the same as the first barrel portion 30 in many respects; for example, the end 54 of the second barrel portion 50 that is adjacent the middle of the second mounting bracket 40 is open and has a cam insert positioned therein. This cam insert is the same as that 35 already described and is located in the second barrel portion 50 in the manner in which the cam insert 35 in the first barrel portion 30 is located.

The two parts of the hinge 10 are positioned relative to one another such that the two barrel portions 30,50 are co-axial and such that the helically-profiled distal ends of each of the two cam inserts 35 inter-engage. The positioning is maintained by the provision of a cylindrical pin 60 that is positioned within each of the two barrel portions 30, 50 and sized so as to extend between the two portions 30,50, through the two cam inserts 35, and so as to be a sliding fit therein. The pin 70 is additionally fixed to the first part of the hinge, for example by pinning, gluing or welding the pin 70 to the first barrel portion 30. Alternatively, the pin 60 may be integrally formed with the first barrel portion 30.

However, and as stated above, the second barrel portion 50 differs from the first barrel portion 30 and from that of know self-closing hinges. The second barrel portion 50 differs in being longer than the first portion 30 so as to project some way beyond the end of the edge of the second mounting bracket 40 along which it is extends and to form a barrel portion extension 70.

The barrel portion extension 70 has a damper 72 positioned therein. The damper is of the type that has a cylindrical plunger 74 mounted for linear and co-axial movement in a cylindrical housing 76. It is envisaged, however, that any suitable form of damper may be used. The damper 72 is such that movement of the plunger 74 in the housing 76 is both damped and sprung to return to a particular position. The damper 72 is positioned in the barrel portion extension 70 with an exposed end of the plunger 74 in contact with an adjacent end of the cylindrical pin 60 and with an end of the damper housing 76 opposite to the exposed end of the plunger 74 attached to a closed end 52 of the barrel portion extension 70. Any suitable form of attachment is envisaged, such as pinning, welding, gluing or attachment involving screw threads. For example the plunger housing 76 may have a thread formed therearound and may be screwed into a cooperatingly threaded bore in the pin 60 barrel extension portion 70.

It is envisaged that the closed end 52 of the barrel portion extension 70 may be so closed by the provision of a removable plug or cap. One such plug is shown at 80 in FIG. 1. This would facilitate insertion and removal of the damper 72 from the remainder of the hinge 10 and would therefore facilitate assembly and disassembly for, for example, maintenance or adjustment. It is also envisaged that the barrel extensions portion 70 be detachable from the remainder of the second barrel portion 50. This would again facilitate assembly and disassembly for maintenance or adjustment.

Prior to operation, the hinge 10 is fitted to a door frame (not shown) and to a door (not shown in FIG. 1) which is to be supported in that frame. The hinge 10 is fitted in much the same way as would be a conventional hinge, that is by affixing each of the first mounting bracket 20 and the second mounting bracket 40 to a respective one of the frame and the door by screwing mounting screws through the holes provided in the brackets 20,40. However, in this embodiment, the hinge 10 is further orientated such that the barrel portion extension 70 extends downwards and such that opening the door results in the two parts of the hinge 10 being forced axially apart by cam action between the juxtaposed helically-profiled cam inserts 35.

In operation, and when the door is opened from a closed position, the first bracket 20 and first barrel portion 30 (including the cam insert 35 fixed thereto) are pivoted relative to the second bracket 40 and second barrel portion 50 (including the cam insert 35 fixed thereto). This causes the first 30 and second 50 barrel portions to be forced axially apart by cam action between the juxtaposed helically-profiled ends of the cam inserts 35. This in turn causes axial separation of the first 20 and second 40 bracket portions. Axial separation of the bracket portions 30,50 results in the door being lifted up with respect to the door frame.

Axial separation of the first barrel portion 30, and hence of the pin 60 attached thereto, from the second barrel portion 50 in this way also allows the plunger 74 to be come at least partially withdrawn from the housing 76. This is because the plunger 74 is resiliently mounted in the damper housing 76 to tend to return to a withdrawn position. Thus, the plunger 74 tends to remain in contact with the pin 60.

Thus, opening of the door causes the door to raise up and the plunger 74 to become at least partly withdrawn.

If the door is then released from its open position, the reverse happens: the weight of the door acts through the hinges and, because of the juxtaposed helically-profiled ends of the cam inserts 35, tends to close the door. This is in much the same way as in operation of a known self-closing hinge. However, in closing, the first barrel portion 30, which is uppermost, moves closer in an axial direction to the second barrel portion 50, which is lowermost. This requires depression of the plunger 74 within the damper housing 76 under influence of the pin 60, which is of course attached to the first barrel portion 30. This depression of the plunger 74 is damped—this being the principal purpose of the damper—and thus closing of the door is also damped. In this way, the hinge 10 discourages slamming of the door and instead tends to cause the door to close in a controlled manner.

With reference to FIG. 2, a second, alternative, hinge 100 in shown that embodies this invention and that is for retro-fitting to a door (not shown) that is already mounted on self-closing hinges. The second hinge 100 is similar to the first hinge 10, but is not self-closing. Thus, the second hinge 100 has a first mounting bracket 120 with a first barrel portion 130 attached thereto and a second mounting bracket 140 with a second barrel portion 150 attached thereto, but differs in that its barrel portions 130,150 do not have cam insets 35 therein. Some form of bearing may, however, be substituted for the cam inserts 35 of the previously-described hinge 10 in order to prevent the two barrel portions 130,150 bearing directly on one another. Some appropriate bearings are shown at 235 in FIG. 2.

The second hinge 100 does, however, have a pin 160, a barrel portion extension 170 and a damper 172 therein that are all the same as the corresponding components of the first hinge 10 and that cooperate in the same fashion. Thus, the second hinge 100 operates in a similar manner as the first hinge 10 in allowing, but damping, axial movement of one part of the hinge relative to the other. Pivotal movement of one part of the second hinge 100 relative to the other does not however, in itself, cause axial separation. This allows the second hinge 100 to be retro-fitted to a door (not shown) that is already mounted on self-closing hinges and to operate to dampen the self-closing of such a door.

FIG. 3 shows a third hinge that is a floor-mounted hinge 200 and that constitutes at least part of a third embodiment of this invention. The floor-mounted hinge 200 is arranged to work in substantially the same way as the hinge 10 described above with reference to FIG. 1 in that it is self-closing but with damping. The principal difference is that the floor-mounted hinge 200 has door and floor mounting brackets that are arranged perpendicular to the pivot axis of the hinge 200 and for attachment to a lower edge 202 of a door 207 and to the floor 205 for pivotal mounting of the door 207 on the floor 205.

In more detail, and with continued reference to FIG. 3, the floor-mounted hinge 200 includes a floor bracket 220 for attachment to the floor 205. The floor bracket 220 has a floor barrel portion 230 attached thereto and with a cam insert 35, such as those described previously with reference to FIG. 1, fixed therein. A pin 260 is co-axially mounted in the floor barrel portion 230 so as to projecting through the barrel portion 230 and the cam insert 35. The pin 260 is attached to the floor barrel portion 230. The pin 260 also projects through a door barrel portion 250 which is mounted on a door bracket 240. The door barrel portion 250 also has a cam insert 35 fixed therein and arranged so as to lie adjacent that 35 in the floor barrel portion 230.

The door bracket 240 has a hole formed therein that is co-axial with the door barrel portion 250. The material that defines this hole is threaded and a damper 272 is located therein by way of a cooperating thread formed on the outside of a housing 276 of the damper 272. Thus, the damper 272 projects inside the door 207. The damper 272 is arranged such that a plunger 274 thereof projects downwards through the door barrel portion 250 into contact with an uppermost end of the pin 260. The plunger 274 is attached to this end of the pin 260. To secure the damper 272 in its location a locking nut 280 is provided around the housing 276 thereof that can be tightened against an upper surface of the door bracket 240.

To allow access to the damper 272, the door 207 is provided with a cut-out channel 208 formed in one face of the door 207 and into which the housing 276 of the damper 272 fits. Although not shown, it is envisaged that a cover plate would be provided to cover the cut-out 208, for example by being screwably fixable to surrounding structure of the door 207.

Although the configuration of the floor-mounted hinge 200 is different to the hinge 10 described above with reference to FIG. 1, the manner of operation is substantially the same and results in damped self-closing of an opened door.

As is shown in FIG. 4, a cut-out channel 209 may instead be provided in an edge of the door 207, such as an edge of the door that is adjacent and generally parallel to the pivot axis.

FIG. 5 shown an offset floor-mounted hinge 300 that is a modification of the floor-mounted hinge 200 shown in and described above with reference to FIGS. 3 and 4. This offset floor-mounted hinge 300 differs in that the door bracket 340 thereof includes an arm 345 that projects away from the door 207, to one side. The door barrel portion 250 of the third hinge 200, which includes the cam insert 35, is attached to an underside of the arm 345. The floor barrel portion 230, the cam insert 35 fixed therein, the pin 260 and the floor bracket 220 are as before. However, the damper 272 is threadedly mounted in a hole formed in the arm 345, with the plunger 274 projecting therethrough to connect to the pin 260. A removable cover 390 is placed over the housing 276 of the damper 272. Thus, the damper 272 lies outside the door 207. This hinge operates in substantially the same manner as the floor-mounted hinge 200 described above with reference to FIGS. 3 and 4.

1. A hinge having one part pivotable relative to another part about an axis, each part also being axially moveable relative to the other, wherein the hinge includes a damper arranged to dampen at least some axial movement of the one part relative to the other.

2. A hinge according to claim 1, wherein the damper is arranged such that it dampens axial coming together of the two parts of the hinge.

3. A hinge according to claim 1, wherein the damper is arranged such that it dampens axial separation of the two parts of the hinge.

4. A hinge according to claim 1, wherein the damper has one part and another part, one part of the damper being arranged to be acted upon by one part of the hinge and the other part of the damping means being arranged to be acted upon by the other part of the hinge, the damper being arranged such that at least some movement of the one part of the damper relative to the other part of the damper is dampened.

5. A hinge according to claim 1 and arranged such that the damper is acted upon in a substantially axial direction by the two parts of the hinge.

6. A hinge according to claim 1 that is a self-closing hinge.

7. A hinge according to claim 1 and arranged such that an axial compressive or tensile force acting on the two parts of the hinge causes the one part of the hinge to pivot relative to the other part of the hinge.

8. A hinge according to claim 6 and including a cam arrangement that gives this result.

9. A hinge according to claim 1, wherein each part of the hinge includes a respective mounting portion and a respective pivot portion, each mounting portion being for mounting to one of supporting structure and structure that is to be supported, and each pivot portion being for pivotally engaging the respective other pivot portion such that the one part of the hinge can pivot relative to the other part.

10. A hinge according to claim 9, wherein at least one of the mounting portions is a mounting bracket and is for fitting to at least one of a surface that extends in an axial direction and a surface that extends in a radial direction.

11. A hinge according to claim 10, wherein at least one of the mounting brackets extends in one of an axial direction and a radial direction.

12. A hinge according to claim 9, wherein each pivot portion includes a respective barrel portion for receiving a pin that is also received in the respective other barrel portion and wherein at least one of the pivot portions houses the damper.

13. A hinge according to claim 12, wherein the damper is operable to act on the pin and also on one pivot portion, the other pivot portion being arranged such that it is acted on by the pin.

14. A door that includes a hinge according to claim 1.

15. A door according to claim 14 that includes a cut-out in which at least part of the hinge is located.

16. A hinge having one part pivotable relative to another part about an axis, each part also being axially moveable relative to the other, wherein the hinge includes a damper arranged to dampen at least some axial movement of the one part relative to the other and said damper has one part and another part, one part of the damper being arranged to be acted upon by one part of the hinge and the other part of the damper being arranged to be acted upon by the other part of the hinge, the damper being arranged such that at least some movement of the one part of the damper relative to the other part of the damper is dampened.

17. A damper for use in a hinge having one hinge part pivotable to another hinge part about an axis, each hinge part also being axially moveable relative to the other, the damper being arranged to dampen at least some axial movement of said one hinge part relative to the other, said damper having one part and another part, said one part of the damper being arranged to be acted upon by said one hinge part and the other part of the damper being arranged to be acted upon by the other hinge part, and the damper being arranged such that at least some movement of said one part of the damper relative to the other part of the damper is dampened.
